(19) United States
(12) Patent Application Publication
(10) Pub. No.: US 2020/0207231 A1
(43) Pub. Date: Jul. 2, 2020

(54) CHARGE CONTROLLER

(71) Applicant: Mitsubishi Electric Corporation, Tokyo (JP)

(72) Inventor: Takuto SUZUKI, Tokyo (JP)

(73) Assignee: Mitsubishi Electric Corporation, Tokyo (JP)

(21) Appl. No.: 16/611,447

(22) PCT Filed: Oct. 23, 2018
(86) PCT No.: PCT/JP2018/039355

§ 371 Date: Nov. 6, 2019

(51) Int. Cl. B60L 53/62; H02J 7/04; H01M 10/44; B60L 53/30; B60L 53/66; H02J 7/00

(52) U.S. Cl. CPC B60L 53/62; H02J 7/04; H01M 10/44; H02J 2310/48; B60L 53/665; H02J 7/00714; H02J 7/00034; B60L 53/305

(57) ABSTRACT

A charge controller includes: a power converter that converts alternating-current power into direct-current power, and supplies the direct-current power to a storage battery mounted in an EV; and a controller that determines whether to stop charging being performed on the storage battery of the EV by the power converter, on a basis of the value of the current flowing from the power converter to the storage battery of the EV when the storage battery of the EV is being charged.

### FIELD

The present invention relates to a charge controller connected to an electric vehicle.

### BACKGROUND

As electric vehicles (hereinafter referred to as EVs) have spread recently, charging spots for charging storage batteries mounted in EVs are increasing. Attention is also drawn to the V2H (Vehicle to Home) system, which is a system for supplying the electric power stored in a storage battery of an EV to home electric appliances in a household. In a case where a storage battery of an EV is charged, a charge controller is used to convert alternating-current power supplied from a commercial power source or the like into direct-current power, and supply the direct-current power to the storage battery. Further, in the V2H system, a charge controller is also used in a case where the direct-current power stored in a storage battery of an EV is converted into alternating-current power, and the alternating-current power is supplied to the home electric appliances in a household.

An electric vehicle and a charge controller need to exchange information about charging to perform charging, and determine the parameters related to charging on the basis of the exchanged information. As an example, the CHAdeMO Association has set the CHAdeMO Protocol as a standard for information to be exchanged between an electric vehicle and a charge controller. An electric vehicle and a charge controller use a communication system called Controller Area Network (CAN), to transmit notifications of information about a charge start, a charge stop, various kinds of parameters such as the upper limit value of the charging current, abnormal detection, the current value at present, and the like, according to the CHAdeMO Protocol.

Normally, a storage battery mounted in an electric vehicle is charged by a constant voltage constant current (hereinafter referred to as CVCC) method. The CVCC method is a method for charging a storage battery with a constant current at the start of the charging, and switching to constant voltage charging when the storage battery is almost fully charged. By the CVCC method, the charging current gradually decreases after the charging is switched to the constant voltage charging. Taking advantage of such characteristics of the CVCC method, Patent Literature 1 discloses a technique by which an electric vehicle transmits a charge stop instruction when determining full charge on the basis of the value of the charging current, and a charge controller stops the supply of the charging current in accordance with the charge stop instruction.

### CITATION LIST

### Patent Literature

Patent Literature 1: Japanese Patent No. 5097289

### SUMMARY

### Technical Problem

However, a method of determining full charge from the charging current of an electric vehicle is based on a determination specification unique to each electric vehicle manufacturer. Furthermore, any method of issuing a charge stop instruction has not been specified, and therefore, the specification varies among the electric vehicle manufacturers. In some cases, it is also conceivable that a charge controller recognizes a charge stop instruction from an electric vehicle as some abnormal stop instruction.

In this case, if the charge controller erroneously performs an abnormal stop due to a charge stop instruction from the electric vehicle, there is a possibility that operation cannot be started unless a process for eliminating abnormality is performed.

The present invention has been made in view of the above, and aims to obtain a charge controller capable of avoiding an abnormal stop due to an instruction from an electric vehicle.

### Solution to Problem

To solve the above problems and achieve the object a charge controller according to the present invention includes: a power converter to convert alternating-current power into direct-current power, and supply the direct-current power to a storage battery mounted in an electric vehicle; and a controller to determine whether to stop charging being performed on the storage battery by the power converter, on a basis of the value of a current flowing from the power converter to the storage battery when the storage battery is being charged.

### Advantageous Effects of Invention

A charge controller according to the present invention achieves an effect to be capable of avoiding erroneous stop due to an instruction from an electric vehicle.

### BRIEF DESCRIPTION OF DRAWINGS

FIG. 1 is a diagram illustrating an example configuration of a charge controller according to a first embodiment.

FIG. 2 is a diagram illustrating an example configuration of the controller included in a charger according to the first embodiment.

FIG. 3 is a flowchart illustrating a process in which the charge controller according to the first embodiment charges a storage battery.

FIG. 4 is a diagram illustrating an example case where a processing circuit included in the charger according to the first embodiment is formed with a processor and a memory.

FIG. 5 is a diagram illustrating an example case where the processing circuit included in the charger according to the first embodiment is formed with dedicated hardware.

FIG. 6 is a flowchart illustrating a process in which a charge controller according to a second embodiment charges a storage battery.

### DESCRIPTION OF EMBODIMENTS

The following is a detailed description of charge controllers according to embodiments of the present invention, with reference to the drawings. Note that the present invention is not limited by the embodiments.

### First Embodiment

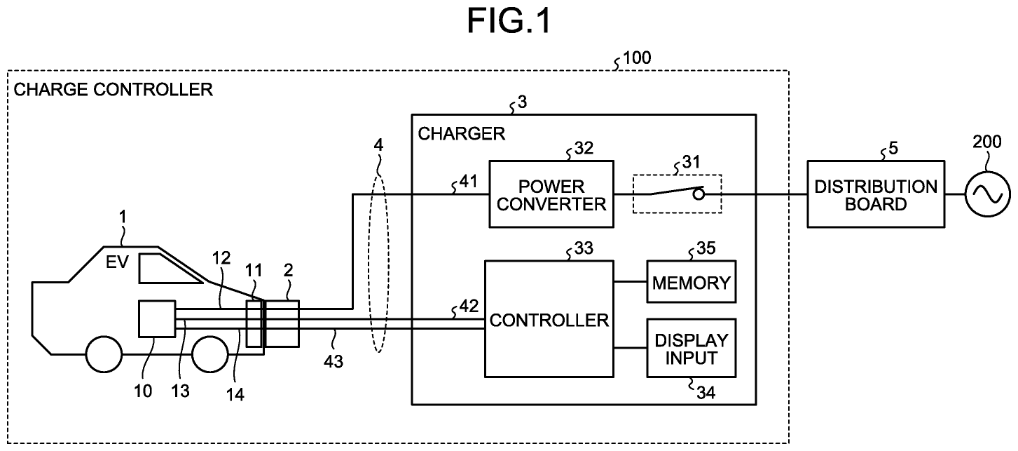

FIG. 1 is a diagram illustrating an example configuration of a charge controller 100 according to a first embodiment of the present invention. The charge controller 100 includes: an EV 1 equipped with a storage battery 10; a connector 2 connected to the EV 1; a charger 3 that converts alternating-current power supplied from a power system 200 into direct-current power via a distribution board 5 for household use, and charges the EV 1 with the direct-current power; and a charging cable 4 that connects the connector 2 and the charger 3 to each other. Note that the EV 1 is an example of an electric vehicle, and the charge controller 100 can also be connected to a plug-in hybrid electric vehicle (PHEV), instead of the EV 1.

The EV 1 includes the storage battery 10, a vehicle power receiver 11, a power line 12 connecting the storage battery 10 and the vehicle power receiver 11 to each other, a communication line 13, and a communication start signal line 14. The storage battery 10 is a storage battery that stores direct-current power supplied from the charger 3. The vehicle power receiver 11 is a connecting unit to which the connector 2 of the charge controller 100 is connected. The power line 12 supplies direct-current power that is input from the charger 3 via the vehicle power receiver 11, to the storage battery 10. The communication line 13 is used for communicating information relating to charging of the storage battery 10 between the charger 3 and the EV 1. The information relating to charging of the storage battery 10 is information about the charging rate of the storage battery 10 and the value of the current charging current, for example. The value of the current charging current is the current value of the direct-current power supplied from the charger 3 to the EV 1 to charge the storage battery 10. The communication start signal line 14 transmits a communication start signal that is input from charger 3 via the vehicle power receiver 11, to the storage battery 10.

The EV 1 also has a function to determine whether to stop charging on the basis of the value of the current charging current received from the charger 3, and forcibly stop the charger 3 to perform the charging. The condition for stopping the charging is that a situation in which the value of the current charging current is smaller than the value of a vehicle charge stop current Ia continues for a charge stop period Ta, for example. The value of the vehicle charge stop current Ia is a first threshold to be used for determining that the storage battery 10 is fully charged in a case where the storage battery 10 approaches full charge and the charging current value gradually decreases in a state of constant voltage charge according to the CVCC method. The charge stop period Ta is the prescribed period to be used in determining whether to stop charging of the storage battery 10.

The charger 3 includes an interconnection switch 31, a power converter 32, a controller 33, a display input 34, and a memory 35. The interconnection switch 31 is connected to the distribution board 5, and connects or disconnects the charger 3 to or from the power system 200 connected to the distribution board 5. The power converter 32 converts alternating-current power supplied from the power system 200 into direct-current power, and supplies the converted direct-current power to the storage battery 10 mounted in the EV 1, to charge the storage battery 10. On the basis of the value of the current flowing from the power converter 32 to the storage battery 10 when the storage battery 10 of the EV 1 is charged, the controller 33 determines whether to stop the charging being performed on the storage battery 10 by the power converter 32. Specifically, the controller 33 controls the start of charging of the storage battery 10 of the EV 1, and controls the stop of charging of the storage battery 10 of the EV 1, depending on conditions such as the charging rate of the storage battery 10 and the value of the current charging current. The controller 33 also controls communication between the charger 3 and the EV 1. The display input 34 has the functions of a display unit that provides the user with various kinds of information using a display screen, and the functions of an input unit that receives user operations. The memory 35 stores information indicating the charge settings. The memory 35 may store the information indicating the charge settings in advance, or may store the information received from the user via the display input 34.

The charging cable 4 is a cable for supplying the direct-current power for charging, and transmitting information relating to charging of the storage battery 10, a communication start signal, and the like. The connector 2 and the charger 3 are connected via the charging cable 4. The charging cable 4 includes a power line 41, a communication line 42, and a communication start signal line 43. One end of each of the power line 41, the communication line 42, and the communication start signal line 43 is connected to the connector 2. The other end of the power line 41 is connected to the direct-current output terminal of the power converter 32. The other ends of the communication line 42 and the communication start signal line 43 are connected to the controller 33. When the connector 2 is connected to the vehicle power receiver 11 of the EV 1, the power line 41 is connected to the power line 12 of the EV 1, the communication line 42 is connected to the communication line 13 of the EV 1, and the communication start signal line 43 is connected to the communication start signal line 14 of the EV 1.

The power line 41 supplies the direct-current power converted by the power converter 32 to the EV 1 via the connector 2. The communication line 42 is used for communicating information relating to charging of the storage battery 10 between the controller 33 and the EV 1. The method of communication to be performed via the communication line 42 may be a communication method using a communication protocol that can be installed in the EV 1 and the charger 3, such as CAN. The communication start signal line 43 transmits, to the storage battery 10, a communication start signal that can be switched between an ON-state and an OFF-state by the controller 33. For example, the controller 33 transmits a predetermined first voltage value signal to the communication start signal line 43, to put the communication start signal line 43 into an ON-state. The controller 33 adjusts the value of the voltage to be applied to the communication start signal line 43 to 0, to put the communication start signal line 43 into an OFF-state. When the communication start signal line 43 is put into an ON-state, the charger 3 starts communication with the EV 1 via the communication line 42.

The charging cable 4 may be a cabtire cable in which each of the electric wires including the power line 41, the communication line 42, and the communication start signal line 43 is doubly insulated by a sheath. As the sheaths of the cabtire cable, vinyl sheaths may be used in a case where importance is put on cost reduction, or rubber sheaths may be used in a case where importance is put on easy handling at low temperature.

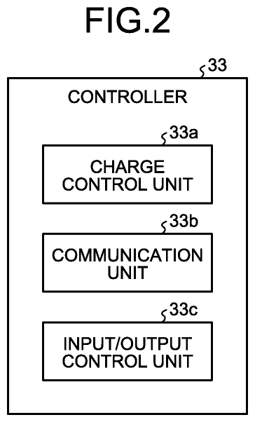

FIG. 2 is a diagram illustrating an example configuration of the controller 33 included in the charger 3 according to the first embodiment. The controller 33 includes a charge control unit 33a, a communication unit 33b, and an input/output control unit 33c. The charge control unit 33a controls the start of charging of the storage battery 10 of the EV 1, and controls the stop of charging of the storage battery 10 of the EV 1, depending on conditions such as the charging rate of the storage battery 10 and the value of the current charging current. When charging of the storage battery 10 is started in the EV 1, the charge control unit 33a periodically acquires the information necessary for charging, such as the charging rate of the storage battery 10, from the EV 1 via the communication unit 33b. When charging of the storage battery 10 is started in the EV 1, the communication unit 33b starts communication with the EV 1, and periodically exchanges information. Specifically, the communication unit 33b receives information such as the charging rate of the storage battery 10 from the EV 1, and transmits information such as the value of the current charging current to the EV 1. The input/output control unit 33c generates the display screen to be output using the display unit of the display input 34, and controls the display content. The input/output control unit 33c also causes the memory 35 to store information indicating the charge settings that are set by the user using the display input 34. The information indicating the charge settings is the upper limit charging rate of the charging for determining a stop of charging of the storage battery 10, for example.

The input/output control unit 33c outputs the display screen using the display input 34, and receives an input operation acquired via the functions of the input unit included in the display input 34. An input operation is setting of the upper limit charging rate of the charging for stopping charging of the storage battery 10. In a case where the charging rate of the storage battery 10 reaches the upper limit charging rate of charging, the charger 3 stops the charging of the storage battery 10. The input/output control unit 33c can also display, on the display input 34, the charging rate of the storage battery 10 acquired from the EV 1. The input/output control unit 33c can also display, on the display input 34, a message informing the user whether the charging of the storage battery 10 has been fully charged or whether the charging of the storage battery 10 has been stopped for some other reason.

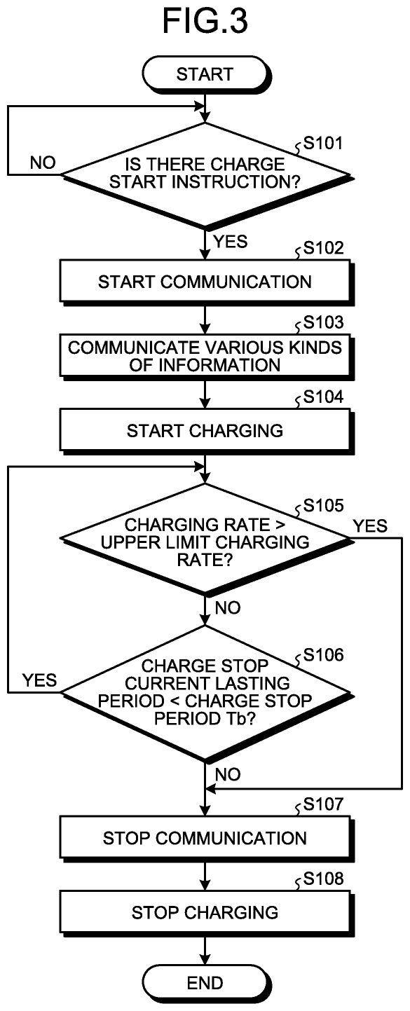

Next, a process in which the charge controller 100 charges the storage battery 10 of the EV 1 is described. FIG. 3 is a flowchart illustrating a process in which the charge controller 100 according to the first embodiment charges the storage battery 10. In the charge controller 100, the charge control unit 33a of the controller 33 determines whether there is a charge start instruction (step S101). The charge start instruction is issued by the user via the display input 34 of the charge controller 100, for example. If there is no charge start instruction (step S101: No), the charge control unit 33a repeats step S101 until a charge instruction is issued.

If there is a charge start instruction (step S101: Yes), the charge control unit 33a notifies the communication unit 33b that there is a charge start instruction. Receiving the notification of the charge start instruction from the charge control unit 33a, the communication unit 33b puts the communication start signal line 43 into an ON-state, to start communication with the EV 1 (step S102). The communication unit 33b performs communication of various kinds of information with the EV 1 (step S103). Specifically, the communication unit 33b receives, from the EV 1, the information necessary for charging the storage battery 10, such as the charging rate of the storage battery 10, and transmits information such as the value of the current charging current to the EV 1.

The charge control unit 33a drives the power converter 32 to convert alternating-current power supplied from the power system 200 via the distribution board 5 into direct-current power, and starts charging the EV 1 using the direct-current power (step S104). The charge control unit 33a compares the acquired charging rate of the storage battery 10 with the upper limit charging rate of charging (step S105). If the acquired charging rate of the storage battery 10 is higher than the upper limit charging rate of charging (step S105: Yes), the charge control unit 33a notifies the communication unit 33b that the charging is to be stopped. Receiving the notification of a charge stop from the charge control unit 33a, the communication unit 33b puts the communication start signal line 43 into an OFF-state, to stop the communication with the EV 1 (step S107). The charge control unit 33a stops the driving of the power converter 32, and stops the charging of the EV 1 (step S108).

If the acquired charging rate of the storage battery 10 is equal to or lower than the upper limit charging rate of charging (step S105: No), the charge control unit 33a counts a charge stop current lasting period during which the value of the current charging current is equal to or lower than the value of the charge stop current. The charge control unit 33a compares the charge stop current lasting period with a charge stop period Tb (step S106). If the charge stop current lasting period is shorter than the charge stop period Tb (step S106: Yes), the charge control unit 33a returns to the processing in step S105. If the charge stop current lasting period is equal to or longer than the charge stop period Tb (step S106: No), the charge control unit 33a notifies the communication unit 33b that the charging is to be stopped. Receiving the notification of a charge stop from the charge control unit 33a, the communication unit 33b puts the communication start signal line 43 into an OFF-state, to stop the communication with the EV 1 (step S107). The charge control unit 33a stops the driving of the power converter 32, and stops the charging of the EV 1 (step S108).

As described above, the charge control unit 33a measures the lasting period during which the value of the current charging current continues to be smaller than the value of the vehicle charge stop current Ia. In a case where the lasting period is equal to or longer than the charge stop period Tb, the charging being performed on the storage battery 10 by the power converter 32 is stopped. Note that the charge stop period Ta>the charge stop period Tb. This is because the charger 3 uses the charge stop period Tb, which is shorter than the charge stop period Ta, so that the charging of the storage battery 10 is stopped before the EV 1 stops the charging of the storage battery 10 using the charge stop period Ta.

In a case where charging of the storage battery 10 has been stopped due to a decrease in the value of the current charging current, the input/output control unit 33c may cause the display input 34 to display a message indicating that the charging of the storage battery 10 has been stopped due to the decrease in the value of the current charging current. In a case where the controller 33 has stopped charging of the storage battery 10, the display input 34 indicates that the cause of the stop is a decrease in the value of the current charging current. Thus, the input/output control unit 33c can notify the user of the cause of the stop of the charging of the storage battery 10.

Next, the configuration of the controller 33 of the charger 3 is described. The controller 33 is formed with a processing circuit. The processing circuit may be formed with a processor that executes a program stored in a memory, and the memory, or may be formed with dedicated hardware.

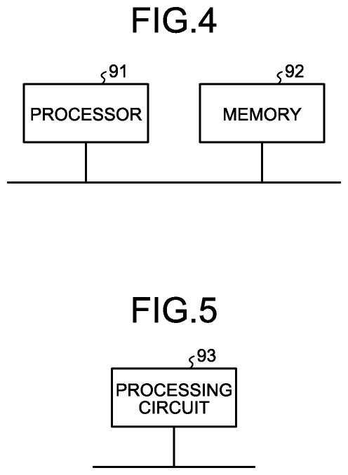

FIG. 4 is a diagram illustrating an example case where the processing circuit included in the charger 3 according to the first embodiment is formed with a processor and a memory. In a case where the processing circuit is formed with a processor 91 and a memory 92, the respective functions of the processing circuit are achieved with software, firmware, or a combination of software and firmware. Software or firmware is written as programs, and is stored in the memory 92. In the processing circuit, the processor 91 reads and executes the programs stored in the memory 92, to achieve the respective functions. These programs can also be regarded as programs for causing a computer to carry out the procedures and the method of the controller 33.

Here, the processor 91 may be a central processing unit (CPU), a processing device, an arithmetic device, a microprocessor, a microcomputer, a digital signal processor (DSP), or the like. Meanwhile, the memory 92 may be a nonvolatile or volatile semiconductor memory such as a random access memory (RAM), a read only memory (ROM), a flash memory, an erasable programmable ROM (EPROM), or an electrically EPROM (EEPROM (registered trademark)), a magnetic disk, a flexible disk, an optical disk, a compact disc, a mini disc, a digital versatile disc (DVD), or the like, for example.

FIG. 5 is a diagram illustrating an example case where the processing circuit included in the charger 3 according to the first embodiment is formed with dedicated hardware. In a case where the processing circuit is formed with dedicated hardware, a processing circuit 93 illustrated in FIG. 5 can be a single circuit, a composite circuit, a programmed processor, a parallel-programmed processor, an application specific integrated circuit (ASIC), a field programmable gate array (FPGA), or a combination thereof, for example. The respective functions of the controller 33 may be achieved with the processing circuit 93 independently of one another, or the respective functions may be collectively achieved with the processing circuit 93.

Note that some of the functions of the controller 33 of the charger 3 may be achieved with dedicated hardware, and the others may be achieved with software or firmware. In this manner, a processing circuit can achieve the above described functions with dedicated hardware, software, firmware, or a combination thereof.

As described above, according to the present embodiment, the charge controller 100 determines a stop of charging of the storage battery 10 of the EV 1, on the basis of the value of the charging current applied to the EV 1. Without the use of a charge stop instruction from the EV 1, the charge controller 100 determines a decrease in the charging current prior to issuance of a charge stop instruction from the EV 1. The charge controller 100 then stops the charging of the storage battery 10 of the EV 1. As a result, the charge controller 100 can appropriately complete the charging process, and avoid an erroneous stop due to an instruction from an electric vehicle.

Although not illustrated in FIG. 1, the charge controller 100 may have a function to convert direct-current power supplied from the EV 1 into alternating-current power, and supply the alternating-current power to the electric load. That is, the charge controller 100 may be a charge/discharge controller capable of performing charging/discharging of direct-current power with the storage battery 10 of the EV 1.

### Second Embodiment

In the first embodiment, the charger 3 appropriately stops charging before the charging is stopped by the EV 1 in the charge controller 100. However, charging of the storage battery 10 might be stopped at a charging rate that is not sufficiently high for the user. For example, there is a case where the charging current from the charger 3 to the EV 1 decreases due to an increase in the load in the household. In a second embodiment, a method in which the charge controller 100 continues to charge the storage battery 10 even when the charging current decreases is described.

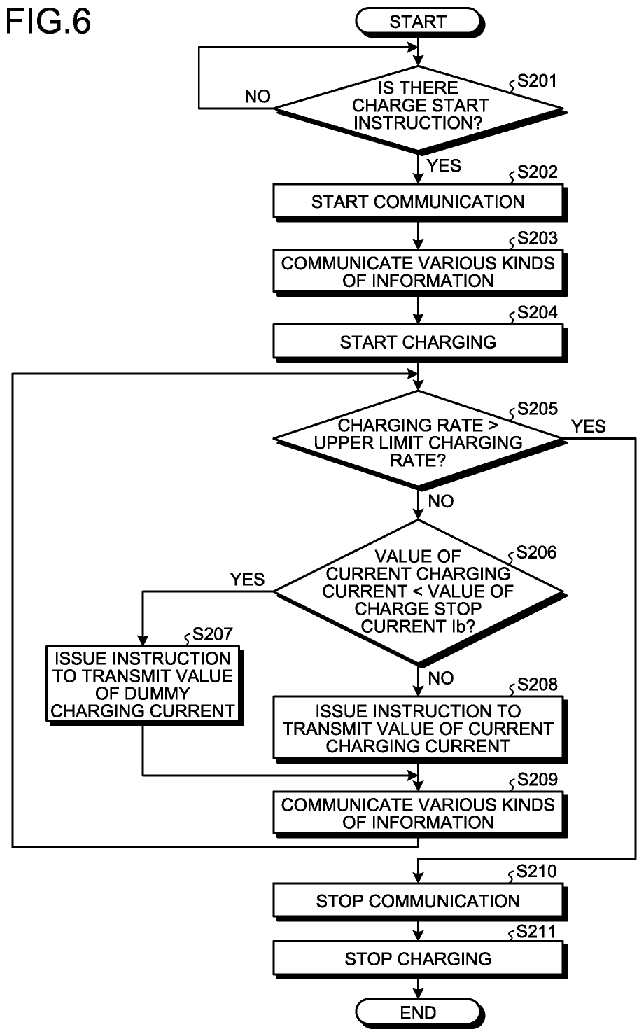

In the second embodiment, the configuration of the charge controller 100 is the same as the configuration of that of the first embodiment illustrated in FIG. 1. In the second embodiment, the process to be performed by the controller 33 of the charger 3 partially differs from the process in the first embodiment. Next, a process in which the charge controller 100 charges the storage battery 10 of the EV 1 is described. FIG. 6 is a flowchart illustrating a process in which the charge controller 100 according to the second embodiment charges the storage battery 10. In the flowchart illustrated in FIG. 6, the process from step S201 to step S205 is the same as the process from step S101 to step S105 in the flowchart of the first embodiment illustrated in FIG. 3.

If the acquired charging rate of the storage battery 10 is equal to or lower than the upper limit charging rate of charging (step S205: No), the charge control unit 33a compares the value of the current charging current with the value of a charge stop current Ib (step S206). The value of the charge stop current Ib is a second threshold to be used in determining whether the charger 3 transmits the value of the current charging current as it is to the EV 1, or whether the value of the current charging current is changed and is then transmitted to the EV 1. Note that the value of the charge stop current Ib>the value of the vehicle charge stop current Ia.

If the acquired value of the current charging current is smaller than the value of the charge stop current Ib (step S206: Yes), the charge control unit 33a instructs the communication unit 33b to transmit a value of a dummy charging current as the value of the current charging current to be transmitted to the EV 1 (step S207). The value of the dummy charging current is not an actual charging current value but a fixed value. Note that the value of the dummy charging current>the value of the vehicle charge stop current Ia. The communication unit 33b performs communication of various kinds of information with the EV 1 (step S209). Specifically, the communication unit 33b receives, from the EV 1, the information necessary for charging the storage battery 10, such as the charging rate of the storage battery 10, and transmits information such as the value of the current charging current to the EV 1. At this stage, the value of the current charging current to be transmitted to the EV 1 by the communication unit 33b is the value of the dummy charging current in practice. The charge control unit 33a returns to the processing in step S205.

If the acquired value of the current charging current is equal to or greater than the value of the charge stop current Ib (step S206: No), the charge control unit 33a instructs the communication unit 33b to transmit the acquired value of the current charging current as the value of the current charging current to be transmitted to the EV (step S208). The communication unit 33b performs communication of various kinds of information with the EV 1 (step S209). Specifically, the communication unit 33b receives, from the EV 1, the information necessary for charging the storage battery 10, such as the charging rate of the storage battery 10, and transmits information such as the value of the current charging current to the EV 1. The charge control unit 33a returns to the processing in step S205.

If the acquired charging rate of the storage battery 10 is higher than the upper limit charging rate of charging (step S205: Yes), the charge control unit 33a notifies the communication unit 33b that the charging is to be stopped. Receiving the notification of a charge stop from the charge control unit 33a, the communication unit 33b stops the communication with the EV 1 (step S210). The charge control unit 33a stops the driving of the power converter 32, and stops the charging of the EV 1 (step S211).

As described above, according to the present embodiment, in a case where the value of the current charging current is smaller than the value of the charge stop current Ib in the charge controller 100, the controller 33 replaces the information about the value of the current charging current to be transmitted to the EV 1 with a prescribed fixed value, and then transmits the fixed value. As a result, the charge controller 100 can continue to charge the storage battery 10 of the EV 1. Thus, the charge controller 100 can charge the storage battery 10 of the EV 1 up to the upper limit charging rate of charging that is set in the charger 3.

The configurations described in the above embodiments are examples of the subject matter of the present invention, and can be combined with other known techniques, or may be partially omitted or modified without departing from the scope of the present invention.

### REFERENCE SIGNS LIST

1 EV; 2 connector; 3 charger; 4 charging cable; 5 distribution board; 10 storage battery; 11 vehicle power receiver; 12, 41 power line; 13, 42 communication line; 14, 43 communication start signal line; 31 interconnection switch; 32 power converter; 33 controller; 33a charge control unit; 33b communication unit; 33c input/output control unit; 34 display input; 35 memory; 100 charge controller; 200 power system.

1. A charge controller comprising:
a power converter to convert alternating-current power into direct-current power, and supply the direct-current power to a storage battery mounted in an electric vehicle; and
a controller to stop charging being performed on the storage battery by the power converter prior to issuance of a charge stop instruction from the electric vehicle, on bases of the value of a current flowing from the power converter to the storage battery and a condition for stopping the charging that the electric vehicle determines when the storage battery is being charged.

2. The charge controller according to claim 1, wherein
when a lasting period during which the value of the current continues to be smaller than a first threshold is measured, and the lasting period is equal to or longer than a prescribed period, the controller stops the charging being performed on the storage battery by the power converter.

3. The charge controller according to claim 1, further comprising
a display unit to display that a cause of a stop of charging is a decrease in the value of the current, when the controller has stopped the charging of the storage battery.

4. The charge controller according to claim 1, wherein
when the value of the current is smaller than a second threshold, the controller replaces information about the value of the current to be transmitted to the electric vehicle with a prescribed fixed value, and transmits the fixed value.

5. The charge controller according to claim 2, further comprising
a display unit to display that a cause of a stop of charging is a decrease in the value of the current, when the controller has stopped the charging of the storage battery.
